(19) United States
(12) Patent Application Publication
(10) Pub. No.: US 2018/0330627 A1
(43) Pub. Date: Nov. 15, 2018

(54) METHOD FOR COLLECTING A VIRTUAL OBJECT AND PORTABLE ELECTRONIC DEVICE FOR IMPLEMENTING THE SAME

(71) Applicant: National Taiwan Normal University, Taipei City (TW)

(72) Inventors: Ming-Yueh HWANG, Taipei City (TW); Jon-Chao HONG, Taipei City (TW); Ming-Chi KIU, Taipei City (TW); Kai-Hsin TAI, Taipei City (TW)

(73) Assignee: National Taiwan Normal University, Taipei City (TW)

(21) Appl. No.: 15/695,386

(22) Filed: Sep. 5, 2017

(30) Foreign Application Priority Data
May 15, 2017 (TW) 106115924

(51) Int. Cl. G09B 5/06; G06F 3/0482; G06F 3/0488; H04N 5/225; G06T 11/60; G09B 5/12; G09B 19/00; G09B 7/02; G09B 7/04

(52) U.S. Cl. CPC G09B 5/065; G06F 3/0482; G06F 3/04883; H04N 5/2253; G09B 7/04; G09B 5/125; G09B 19/0046; G09B 19/00; G09B 7/02; G06T 11/60

(57) ABSTRACT

A method for collecting a virtual object includes: displaying a virtual element associated with a specific virtual object; adding the virtual element into a collected-element list upon receiving a collecting instruction to collect the virtual element; upon receiving an answer request corresponding to a target element in the collected-element list that is associated with a target virtual object, displaying different options each corresponding to a distinct virtual object; upon receiving a user answer of a selected option, determining whether the selected option is one of the options that is associated with the target virtual object; and when the determination is affirmative, adding the target virtual object into a collected-object list.

### CROSS-REFERENCE TO RELATED APPLICATION

This application claims priority to Taiwanese Patent Application No. 106115924 filed on May 15, 2017.

### FIELD

The disclosure relates to a method for collecting a virtual object by using a portable electronic device, and a portable electronic device for implementing the same.

### BACKGROUND

Nowadays, the pathways for acquiring knowledge are not limited to reading books or printed publications. It is worth working on the subject of teaching through edutainment materials.

### SUMMARY

Therefore, an object of the present disclosure is to provide a method for collecting a virtual object and displaying introduction of the virtual object.

According to one aspect of the present disclosure, the method is to be implemented by a portable electronic device including a display, an input unit and a processing unit. The method includes: displaying, by the display, a to-be-collected virtual element that is associated with a specific one of a plurality of virtual objects; adding, by the processing unit, the to-be-collected virtual element into a list of collected virtual elements upon receiving through the input unit a user input of a collecting instruction to collect the to-be-collected virtual element; controlling, by the processing unit, the display to display a plurality of different options upon receiving through the input unit a user input of an answer request that corresponds to at least a target element in the list of collected virtual elements, the target element being associated with a target one of the virtual objects, each of the options corresponding to a distinct one of the virtual objects, a particular one of the options being associated with the target one of the virtual objects; upon receiving through the input unit a user input of a user answer of a selected one of the options, determining, by the processing unit, whether the selected one of the options is the particular one of the options that is associated with the target one of the virtual objects; e) when it is determined that the selected one of the options is the particular one, adding, by the processing unit, the target one of the virtual objects into a list of collected virtual objects.

According to another aspect of the present disclosure, a portable electronic device for implementing a method for collecting a virtual object includes a display, an input unit, and a processing unit electrically connected to the input unit and the display. The processing unit is programmed to control the display to display a to-be-collected virtual element that is associated with a specific one of a plurality of virtual objects, to add the to-be-collected virtual element into a list of collected virtual elements upon receiving through the input unit a user input of a collecting instruction to collect the to-be-collected virtual element, and to control the display to display a plurality of options upon receiving through the input unit a user input of an answer request that corresponds to at least one target element in the list of collected virtual elements. The target element is associated with a target one of virtual objects. Each of the options corresponds to a distinct one of the virtual objects, and a particular one of the options is associated with the target one of the virtual objects. The processing unit is further programmed to, upon receiving through the input unit a user input of a user answer of a selected one of the options, add the target one of the virtual objects into a list of collected virtual objects when the selected one of the options is the particular one of the options.

### BRIEF DESCRIPTION OF THE DRAWINGS

Other features and advantages of the present disclosure will become apparent in the following detailed description of the embodiment with reference to the accompanying drawings, of which:

FIG. 1 is a schematic block diagram of a portable electronic device according to one embodiment of the present disclosure;

FIG. 2 illustrates a flow chart of a collecting procedure of a method for collecting virtual objects according to one embodiment of the present disclosure;

FIG. 3 is a schematic view of an augmented reality (AR) image containing a to-be-collected virtual element associated with a specific one of virtual objects di splayed on a display of the portable electronic device;

FIG. 4 is a flow chart illustrating an answering procedure of the method for collecting virtual objects;

FIG. 5 is a schematic view illustrating a list of collected virtual elements and a plurality of options displayed on the display of the portable electronic device; and

FIG. 6 is a schematic view illustrating an introduction of a target one of the virtual objects.

### DETAILED DESCRIPTION

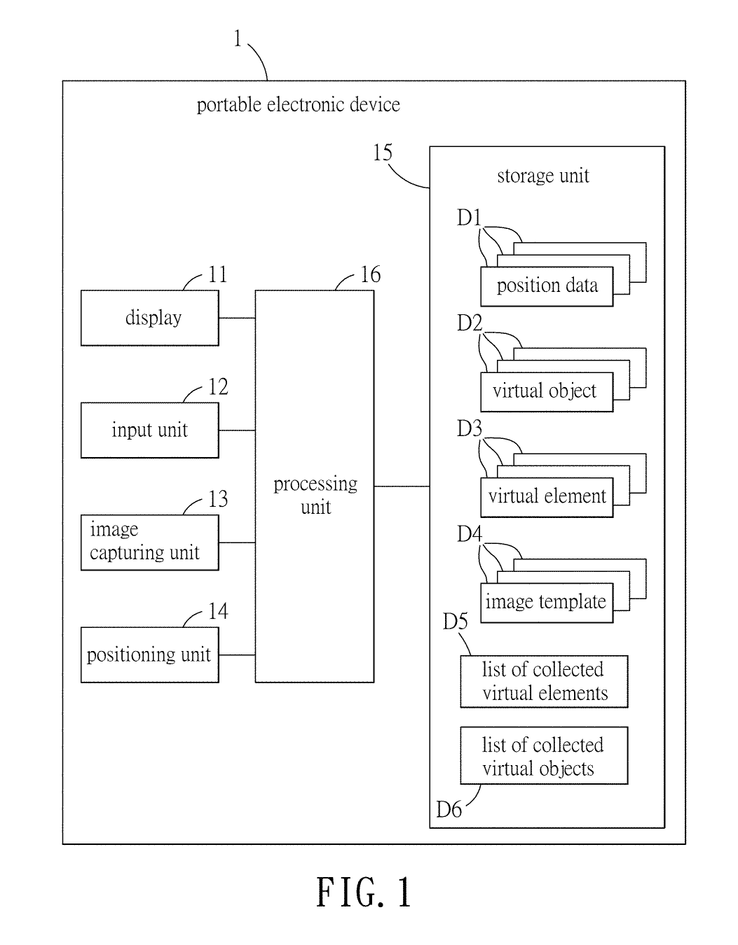

Referring to FIG. 1, a portable electronic device 1 according to an embodiment of this disclosure includes a display 11, an input unit 12, an image capturing unit 13, a positioning unit 14, a storage unit 15 and a processing unit 16. The processing unit 16 is electrically connected to the display 11, the input unit 12, the image capturing unit 13, the positioning unit 14 and the storage unit 15. A plurality of sets of position data D1, a plurality of virtual objects D2, a plurality of virtual elements D3 and a plurality of image templates D4 are pre-stored in the storage unit 15. The sets of position data D1 are also referred to hereinafter as sets of pre-stored position data D1. Note that, in one embodiment, the portable electronic device 1 is a smart phone or a tablet, the display 11 is a screen of the portable electronic device 1, the input unit 12 is a touch pad of the portable electronic device 1, the image capturing unit 13 is a camera of the portable electronic device 1, the storage unit 15 is a memory of the portable electronic device 1, and the processing unit 16 is a central processing unit (CPU) of the portable electronic device 1, but the disclosure is not limited in this aspect.

Each set of the pre-stored position data D1 represents a physical location and is, for example, a set of coordinates in the geographic coordinate system, and one or more landscapes may be seen from different view angles at the physical location. Each landscape is associated with a respective one of the image templates D4. Each set of the pre-stored position data D1 may be associated with one or more virtual elements D3, and each image template D4 may be associated with one or more virtual elements D3.

Each of the virtual objects D2 represents a respective type of one of an animal and a plant. For example, three of the virtual objects D2 are, but not limited to, a Taiwan barbet (megalaima nuchalis), a common moorhen (gallinula chloropus) and a Pallas's squirrel (callosciurus erythraeus), respectively. Each virtual element D3 is associated with a specific one of the virtual objects D2. For example, three of the virtual elements D3 respectively represent a feather of the Taiwan barbet, defecation of the Taiwan barbet and footprints of the Pallas's squirrel. Namely, two of the virtual elements D3 representing the feather and defecation of the Taiwan barbet are both associated with one virtual object D2 that represents the Taiwan barbet, and one of the virtual elements D3 representing the footprint of the Pallas's squirrel is associated with another virtual object D2 that represents the Pallas's squirrel. The disclosure is not limited in this aspect.

It should be noted that each of the virtual objects D2 and the virtual elements D3 is illustrated in a form of image of a true appearance of the corresponding things in the real world. In other embodiments, the virtual objects D2 may be various varieties of plants, and the virtual elements D3 may be leaves, fruits, flowers and so forth of the varieties of plants.

The image capturing unit 13 captures an environment image around the portable electronic device 1, and the positioning unit 14 obtains current position dada indicating a current position of the portable electronic device 1.

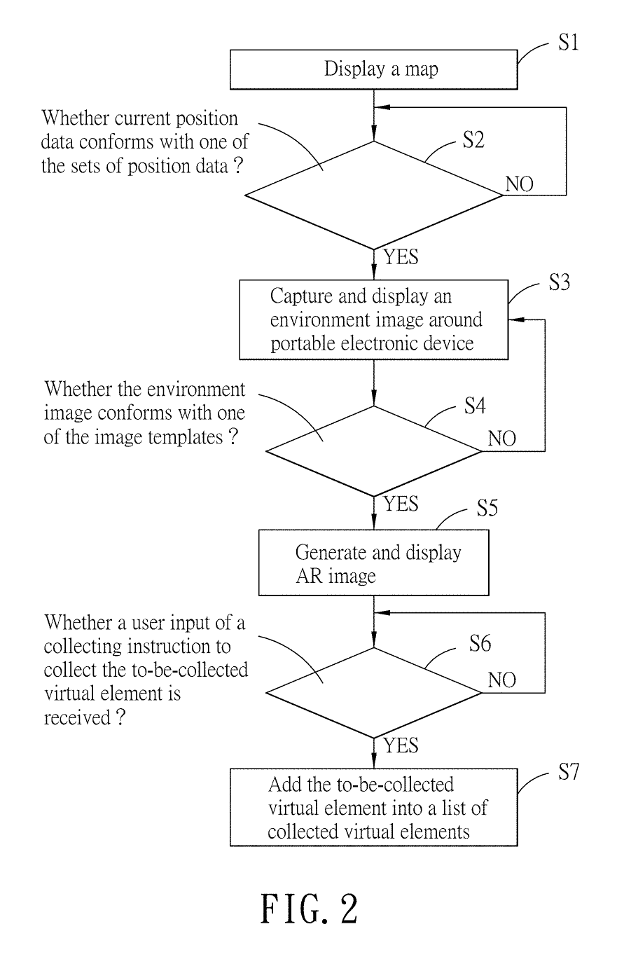

Further referring to FIG. 2, a method for collecting a virtual object is to be implemented by the portable electronic device 1. The method includes a collecting procedure and an answering procedure. In the following, the collecting procedure is described first. In step S1, the display 11 displays a map such as a planimetric map, in which the current position of the portable electronic device 1 obtained from the positioning unit 14 and the sets of pre-stored position data D1 are indicated. A user of the portable electronic device 1 may head toward a location represented by one set of the pre-stored position data D1 according to the map displayed on the display 11.

In step S2, the positioning unit 14 renews the current position data, and the processing unit 16 determines whether the current position data conforms with one of the sets of the pre-stored position data D1. When the determination made in step S2 is affirmative, a flow of the method goes to step S3; otherwise, step S2 is repeated. Note that for ease of illustration, the virtual element D3 with which the set of the pre-stored position data D1, with which the current position data conforms, is associated is referred to as a to-be-collected virtual element D3 in the following description. Although only one to-be-collected virtual element D3 is described in the following, in some embodiments, the set of pre-stored position data D1 may be associated with more than one virtual element D3.

In step S3, the image capturing unit 13 captures an environment image around the portable electronic device 1 as the user holds the portable electronic device 1 to explore the landscapes around the current position, and the display 11 displays the environment image under control of the processing unit 16.

In step S4, the processing unit 16 determines whether the environment image conforms with one of the image templates D4. In some embodiments, the processing unit 16 is programmed to determine whether the environment image conforms with the image template D4 that is associated with the to-be-collected virtual element D3. When the determination made above is affirmative, the flow goes to step S5; otherwise, the flow returns to step S3. The user may act as a “biologist” by holding the portable electronic device 1 and exploring the landscapes around the current position to find the to-be-collected virtual element D3.

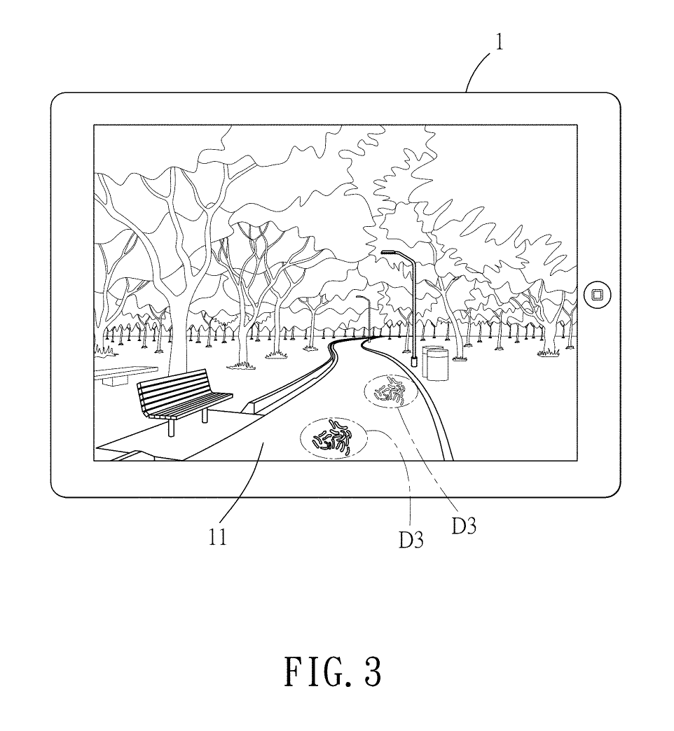

In step S5, the processing unit 16 generates an augmented reality (AR) image by augmenting the environment image with the to-be-collected virtual element D3, and the display 11 of the portable electronic device 1 displays the AR image containing the to-be-collected virtual element D3 (see FIG. 3) under control of the processing unit 16.

Subsequent to step S5, in step S6, the processing unit 16 determines whether a user input of a collecting instruction to collect the to-be-collected virtual element D3 is received through the input unit 12. When the determination made in step S6 is affirmative, the flow goes to step S7; otherwise, the flow returns to step S6. In this embodiment, the collecting instruction is associated with a virtual collecting tool that corresponds to the to-be-collected virtual element D3. For example, the processing unit 16 controls the display 11 to display a plurality of virtual collecting tools including virtual tweezers, a virtual shovel and a virtual camera for collecting the virtual elements D3 of “the feather of the Taiwan barbet”, “the defecation of the Taiwan barbet” and “the footprints of the Pallas's squirrel”, respectively. Note that the collecting instruction is generated only if one of the virtual collecting tools that corresponds to the to-be-collected virtual element D3 is selected by the user through the input unit 12. Specifically, when the user intends to collect the to-be-collected virtual element D3 of “the feather of the Taiwan barbet”, the collecting instruction is generated only if the virtual tweezers are selected.

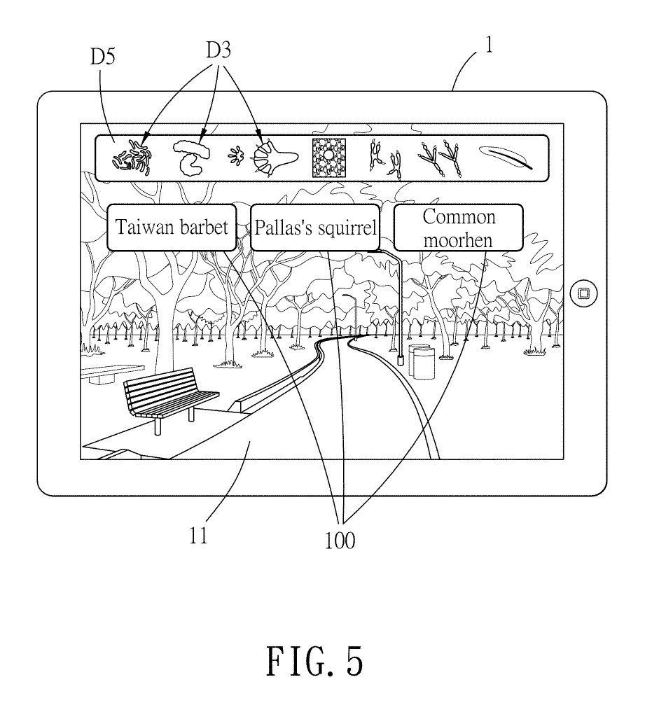

In step S7, the processing unit 16 adds the to-be-collected virtual element D3 into a list of collected virtual elements D5 (see FIG. 1) that is, for example, to be stored in the storage unit 15. As shown in FIG. 5, the display 11 may display the list of collected virtual elements D5 under control of the processing unit 16.

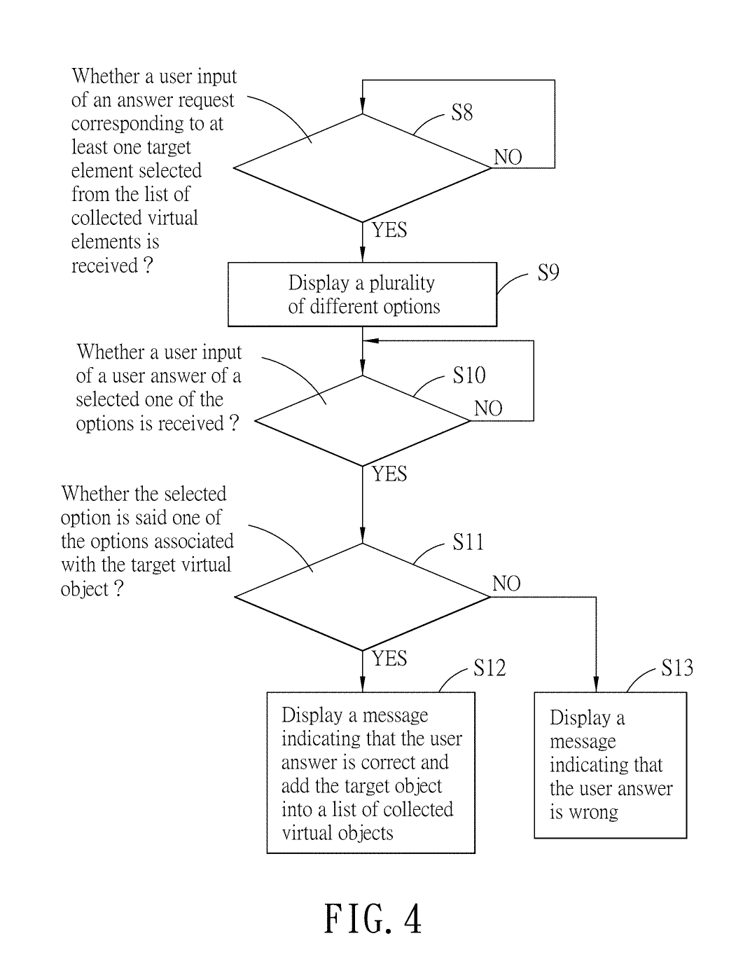

Referring to FIGS. 1, 4 and 5, the answering procedure of the method is described in the following. In step S8, the processing unit 16 determines whether a user input of an answer request that corresponds to at least one target element selected from the list of collected virtual elements D5 is received through the input unit 12. The at least one target element is associated with a target one of the virtual objects D2. Specifically, as shown in FIG. 5, the answer request is generated by selecting one or more virtual elements D3 in the list of collected virtual elements D5 as the at least one target element. For example, when only one virtual element D3 in the list of collected virtual elements D5 is selected as the target element, the answer request is generated. Further, when more than one of the virtual elements D3 in the list of collected virtual elements D5 are selected as the target elements, the answer request is generated only if the selected target elements are all associated with the same virtual object D2 (i.e., the target one of the virtual objects D2). For example, when the virtual elements D3 of “the feather of the Taiwan barbet” and “the defecation of the Taiwan barbet” that are associated with the same virtual object D2 of the Taiwan barbet are selected as the target elements, the answer request is generated. On the other hand, when the virtual elements of “the feather of the Taiwan barbet” and “the footprints of the Pallas's squirrel” that are associated respectively with different virtual objects D2 of “the Taiwan barbet” and “the Pallas's squirrel” are selected by the user, the answer request will not be generated. When the determination made in step S8 is affirmative, the flow goes to step S9; otherwise, the flow returns to step S8.

In step S9, the processing unit 16 controls the display 11 to display a plurality of different options 100. Each of the options 100 corresponds to a distinct one of the virtual objects D2, and one of the options 100 is associated with the target virtual object D2. Each of the options 100 is shown in a form of a box containing text in this embodiment as shown in FIG. 5, and may be presented in other forms (e.g., an image or a video) in other embodiments.

Subsequent to step S9, in step S10, the processing unit 16 determines whether a user input of a user answer of a selected one of the options 100 is received through the input unit 12. When the determination made in step S10 is affirmative, the flow goes to step S11; otherwise, the flow returns to step S10.

In step S11, the processing unit 16 determines whether the selected option 100 is said one of the options 100 that is associated with the target virtual object D2. When the determination made in step S11 is affirmative, the flow goes to step S12; otherwise, the flow goes to step S13.

For example, after the answer request is generated upon the virtual elements D3 of “the feather of the Taiwan barbet” and “the defecation of the Taiwan barbet” associated with the same virtual object D2 of the Taiwan barbet being selected as the target elements in step S8, the options 100 displayed on the display 11 in step S9 are “Taiwan barbet”, “Pallas's squirrel” and “common moorhen”. When the option 100 corresponding to “Taiwan barbet” is selected, the flow goes to step S12; otherwise, the flow goes to step S13.

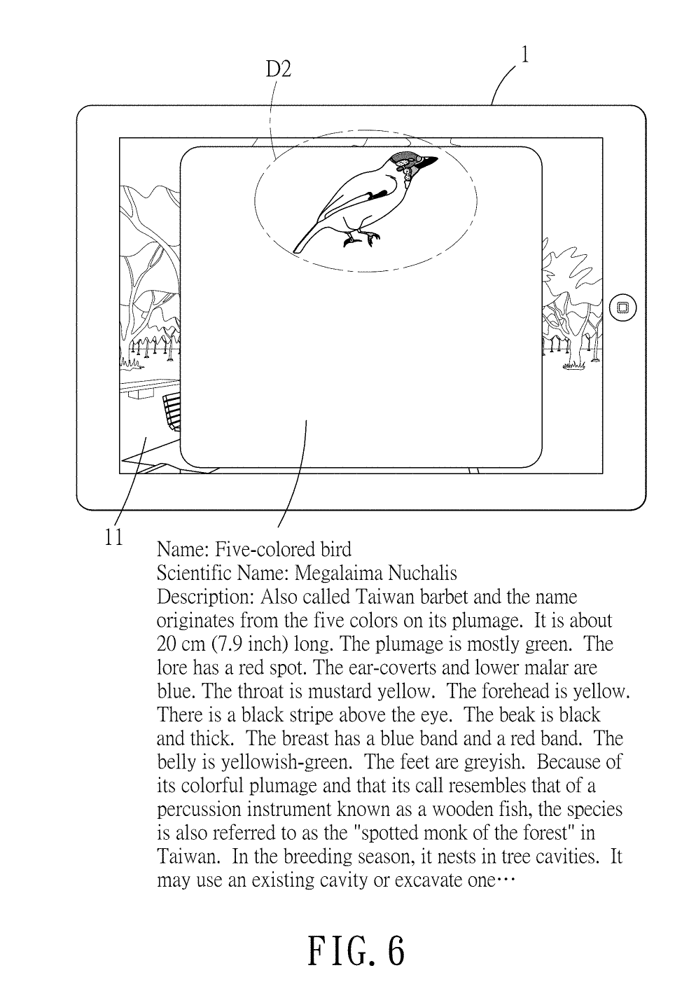

In step S12, the processing unit 16 controls the display 11 to display a message indicating that the user answer is correct, and adds the target virtual object D2 into a list of collected virtual objects D6 (see FIG. 1). Further referring to FIG. 6, the processing unit 16 further controls the display 11 to display an introduction of the target virtual object D2 of the Taiwan barbet.

In step S13, the processing unit 16 controls the display 11 to display another message indicating that the user answer is wrong.

In other embodiments of this disclosure, the processing unit 16 may be programmed to further implement a reward procedure for rewarding the user with a particular amount of a virtual currency when the user answer is correct, and the user may redeem more virtual collecting tools with the virtual currency.

Additionally, in other embodiments of this disclosure, the method may be employed in an indoor environment such as a museum and an art gallery. In such embodiments, the display 11 does not display a map of the indoor environment, and the positioning unit 14 does not operate to obtain the current position data, so step S1 and S2 are omitted. Instead, a plurality of quick response (QR) codes are disposed along a traffic flow for visiting the museum or the art gallery, and each is associated with one or more virtual elements. The user may use the portable electronic device 1 to scan the QR codes by the image capturing unit 13 to collect the virtual element(s) associated with a specific one of the QR codes. The virtual objects may each be an archeological site, a historical site, a sculpture, a pictorial work and so forth, and the virtual elements may each be a riddle, an image, an audio, an introduction associated with the corresponding virtual object, and the disclosure is not limited in this respect.

To sum up, the method according to embodiments of the present disclosure provides the user with fun and knowledge at the same time. Further, since each of the virtual elements D3 is associated with a specific one of the virtual objects D2 corresponding to various animals, the user is required to determine which one of the virtual objects D2 is associated with the image of the to-be-collected virtual element D3. Additionally, the user may review the list of collected virtual objects D6 and the introduction of the virtual objects D2 while feeling fulfilled and accomplished. Finally, the present disclosure may be employed in a museum or an art gallery to thereby provide an interesting yet challenging experiment for the visitors visiting these facilities.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for collecting a virtual object, the method to be implemented by a portable electronic device including a display, an input unit and a processing unit, the method comprising steps of:
displaying, by the display, a to-be-collected virtual element that is associated with a specific one of a plurality of virtual objects;
adding, by the processing unit, the to-be-collected virtual element into a list of collected virtual elements upon receiving through the input unit a user input of a collecting instruction to collect the to-be-collected virtual element;
controlling, by the processing unit, the display to display a plurality of different options upon receiving through the input unit a user input of an answer request that corresponds to at least one target element selected from the list of collected virtual elements, the target element being associated with a target one of the virtual objects, each of the options corresponding to a distinct one of the virtual objects, a particular one of the options being associated with the target one of the virtual objects;
upon receiving through the input unit a user input of a user answer of a selected one of the options, determining, by the processing unit, whether the selected one of the options is the particular one of the options that is associated with the target one of the virtual objects; and
when it is determined that the selected one of the options is the particular one, adding, by the processing unit, the target one of the virtual objects into a list of collected virtual objects.

2. The method of claim 1, the portable electronic device further including an image capturing unit, the method further comprising steps of:
a) capturing, by the image capturing unit, an environment image around the portable electronic device;
b) determining, by the processing unit, whether the environment image conforms with an image template that is pre-stored in the portable electronic device and that is associated with the to-be-collected virtual element;
c) when it is determined that the environment image conforms with the image template, generating, by the processing unit, an augmented reality (AR) image by augmenting the environment image with the to-be-collected virtual element; and
d) controlling, by the processing unit, the display to display the AR image containing the to-be-collected virtual element.

3. The method of claim 2, the portable electronic device further including a positioning unit, the method further comprising, before the step of displaying the to-be-collected virtual element, steps of:
obtaining, by the positioning unit, current position data indicating a current position of the portable electronic device; and
determining, by the processing unit, whether the current position data of the portable electronic device conforms with a set of pre-stored position data that is associated with the to-be-collected virtual element,
wherein steps a) to d) are implemented when it is determined that the current position data conforms with the set of pre-stored position data.

4. The method of claim 2, further comprising a step of repeating steps a) and b) when it is determined that the environment image does not conform with the image template.

5. The method of claim 1, wherein the collecting instruction is associated with a virtual collecting tool that corresponds to the to-be-collected virtual element.

6. The method of claim 5, wherein the virtual collecting tool is displayed on the display, and the user input of the collecting instruction is a selection of the virtual collecting tool using the input unit.

7. The method of claim 1, each of the virtual objects representing a respective type of one of an animal and a plant,
the method further comprising controlling, by the processing unit, the display to display an introduction of the target one of the virtual objects when it is determined that the selected one of the options is the particular one.

8. A portable electronic device comprising:
a display;
an input unit; and
a processing unit electrically connected to said input unit and said display, and programmed to
control said display to display a to-be-collected virtual element that is associated with a specific one of a plurality of virtual objects,
add said to-be-collected virtual element into a list of collected virtual elements upon receiving through said input unit a user input of a collecting instruction to collect said to-be-collected virtual element,
control said display to display a plurality of options upon receiving through said input unit a user input of an answer request that corresponds to at least one target element selected from the list of collected virtual elements, the target element being associated with a target one of virtual objects, each of the options corresponding to a distinct one of said virtual objects, a particular one of the options being associated with the target one of the virtual objects,
upon receiving through said input unit a user input of a user answer of a selected one of the options, determine whether the selected one of the options is the particular one of the options that is associated with the target one of the virtual objects, and
add the target one of the virtual objects into a list of collected virtual objects when the selected one of the options is the particular one of the options.

9. The portable electronic device as claimed in claim 8, further comprising an image capturing unit electrically connected to said processing unit and configured to capture an environment image around the portable electronic device,
wherein said processing unit is further programmed to generate an augmented reality (AR) image by augmenting the environment image with the to-be-collected virtual element when the environment image conforms with an image template that is pre-stored in said portable electronic device and that is associated with the to-be-collected virtual element, and to control said display to display the AR image containing the to-be-collected virtual element.

10. The portable electronic device as claimed in claim 9, further comprising a positioning unit electrically connected to said processing unit and configured to obtain current position data indicating a current position of said portable electronic device,
wherein, when determining that the current position of said portable electronic device conforms with a set of pre-stored position data that is associated with the to-be-collected virtual element, said processing unit controls said image capturing unit to capture the environment image around said portable electronic device, generates the AR image when the environment image conforms with the image template, and controls said display to display the AR image.

11. The portable electronic device as claimed in claim 9, wherein said processing unit is further programmed to continuously control said image capturing unit to capture at least one environment image around said portable electronic device until determining that an environment image captured by said image capturing unit conforms with an image template that is pre-stored in said portable electronic device and that is associated with the to-be-collected virtual element.

12. The portable electronic device as claimed in claim 8, wherein the collecting instruction is associated with a virtual collecting tool that corresponds to said to-be-collected virtual element.

13. The portable electronic device as claimed in claim 12, wherein said processing unit is programmed to control said display to display the virtual collecting tool thereon, and said input unit allows user selection of the virtual collecting tool as the user input of the collecting instruction.

14. The portable electronic device as claimed in claim 8, each of the virtual objects representing a respective type of one of an animal and a plant,
said processing unit is further configured to control said display to display an introduction of the target one of the virtual objects when the selected one of the options is the particular one of the options.
